(19) United States
(12) Patent Application Publication
(10) Pub. No.: US 2019/0355326 A1
(43) Pub. Date: Nov. 21, 2019

(54) OPERATING METHOD OF TRACKING SYSTEM, HMD (HEAD MOUNTED DISPLAY) DEVICE, AND TRACKING SYSTEM

(71) Applicant: HTC Corporation, Taoyuan City (TW)

(72) Inventors: Jiun-Lin CHEN, Taoyuan City (TW); Yu-You WEN, Taoyuan City (TW); Po-Sen YANG, Taoyuan City (TW)

(21) Appl. No.: 16/416,285

(22) Filed: May 20, 2019

Related U.S. Application Data
(60) Provisional application No. 62/674,016, filed on May 20, 2018.

(51) Int. Cl. G09G 5/377; G06T 5/00; G09G 5/373; G06T 3/40

(52) U.S. Cl. CPC G09G 5/377; G06T 5/002; G09G 5/373; G09G 2354/00; G09G 2340/0407; G09G 2340/12; G06T 3/40

(57) ABSTRACT

An operating method of a tracking system is disclosed. The operating method includes the following operations: obtaining, by a processor, a parameter of a lens of a HMD (Head Mount Display) device; calculating, by the processor, data of a foveation area according to the parameter; generating, by the processor, a foveation image according to the foveation area; generating, by the processor, a peripheral image whose resolution is lower than a resolution of the foveation image; and merging, by the processor, the foveation image and the peripheral image to generate a viewing image; and outputting, by the processor, the viewing image.

### RELATED APPLICATIONS

This application claims priority to U.S. Provisional Application Ser. No. 62/674,016, filed May 20, 2018, which is herein incorporated by reference.

### BACKGROUND

### Technical Field

The present disclosure relates to an operating method of a tracking system, a HMD (HEAD MOUNTED DISPLAY) device, and a tracking system. More particularly, the present disclosure relates to an operating method of a tracking system, a HMD device, and a tracking system for generating viewing image.

### Description of Related Art

The high resolution and high framerate are essential and important to good VR (virtual reality) experiencing. High fidelity 3D scenes also bring better VR experience but introduce high GPU loading at the mean time. Thus, it takes high price for qualifies GPU to VR system requirement.

Reducing render solution is a direct solution to reduce GPU loading. However, it is important to maintain viewing quality while reducing rendering resolution.

### SUMMARY

One aspect of the present disclosure is related to an operating method of a tracking system. The operating method includes the following operations: obtaining, by a processor, a parameter of a lens of a HMD (Head Mount Display) device; calculating, by the processor, data of a foveation area according to the parameter; generating, by the processor, a foveation image according to the foveation area; generating, by the processor, a peripheral image whose resolution is lower than a resolution of the foveation image; and merging, by the processor, the foveation image and the peripheral image to generate a viewing image; and outputting, by the processor, the viewing image.

Another aspect of the present disclosure is related to a HMD device. The HMD device includes a HMD device includes a display circuit with a lens and a processer. The processor is configured to obtain a parameter of the lens, to calculate data of a foveation area according to the parameter, to generate a foveation image according to the foveation area, to generate a peripheral image whose resolution is lower than a resolution of the foveation image, to merge the foveation image and the peripheral image to generate a viewing image, and to output the viewing image.

Another aspect of the present disclosure is related to a tracking system. The tracking system includes a client device with a lens and a host device. The host device includes a processor. The processor is configured to obtain a parameter of the lens, to calculate data of a foveation area according to the parameter, to generate a foveation image according to the foveation area, to generate a peripheral image whose resolution is lower than a resolution of the foveation image, to merge the foveation image and the peripheral image to generate a viewing image, and to output the viewing image.

Through the operations of one embodiment described above, the viewing quality is maintained while reducing render resolution.

### BRIEF DESCRIPTION OF THE DRAWINGS

The invention can be more fully understood by reading the following detailed description of the embodiments, with reference made to the accompanying drawings as follows:

FIG. 1A is a schematic block diagram of a HMD (Head Mount Display) device in accordance with some embodiments of the present disclosure.

FIG. 1B is a schematic block diagram of a tracking system in accordance with some embodiments of the present disclosure.

FIG. 2 is a flowchart of an operating method in accordance with some embodiments of the present disclosure.

FIG. 3 is a schematic diagram of a viewing image in accordance with some embodiments of the present disclosure.

FIG. 4 is a schematic diagram of an eye tracking operation in accordance with some embodiments of the present disclosure.

FIG. 5 is a schematic diagram of the viewing image in accordance with some embodiments of the present disclosure.

FIG. 6 is a schematic diagram of the foveation image in accordance with some embodiments of the present disclosure.

FIG. 7 is a schematic diagram of the peripheral image in accordance with some embodiments of the present disclosure.

FIG. 8 is a schematic diagram illustrating the output of the viewing image seen by a user.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

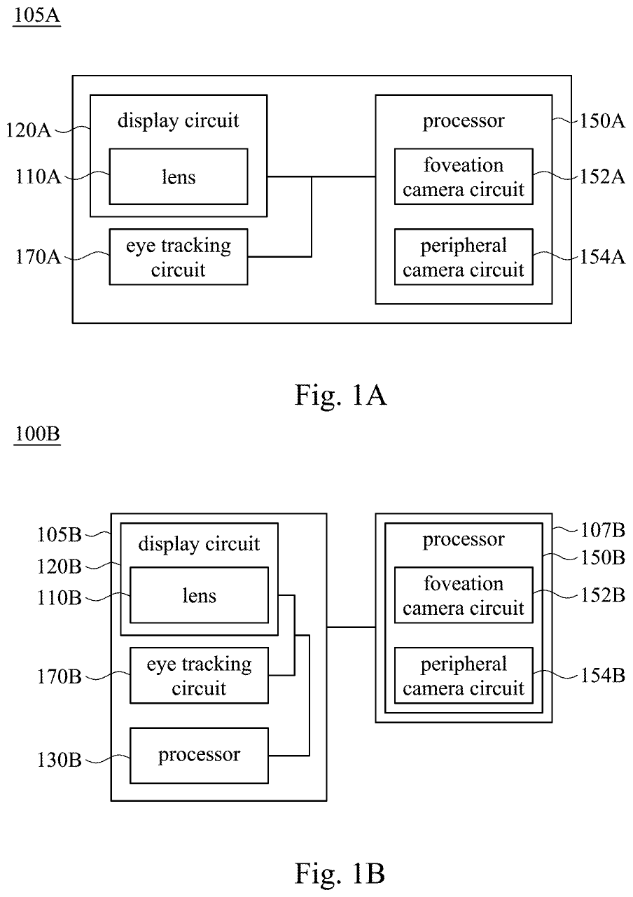

FIG. 1A is a schematic block diagram of a HMD (Head Mount Display) device 105A in accordance with some embodiments of the present disclosure. As illustrated in FIG. 1A, the HMD device 105A includes a display circuit 120A and a processor 150A. The display circuit 120A includes a lens 110A. In some embodiments, the HMD device 105A further includes an eye tracking circuit 170A. The display circuit 120A and the eye tracking circuit 170A are electronically coupled to the processor 150A.

FIG. 1B is a schematic block diagram of a tracking system 100B in accordance with some embodiments of the present disclosure. As illustrated in FIG. 1B, the tracking system 100B includes a client device 105B and a host device 107B. The tracking system can be implemented as, for example, virtual reality (VR), augmented reality (AR), mixed reality (MR), or such like environments. In some embodiments, the host device 107B communicates with the client device 105B via wired or wireless connection, such as Bluetooth, WIFI, USB, and so on.

In some embodiments, the host device 107B includes a processor 150B. In some embodiments, the client device 105B further includes a processor 130B, an eye tracking circuit 170B and a display circuit 120B. The display circuit 120B includes a lens 110B. The display circuit 120B and the eye tracking circuit 170B are electronically coupled to the processor 130B.

Due to the optical effects such as the parameters of focal length, a field of view, or other process issue, for example, the pixel density per degree at peripheral area is lower than center area. For the peripheral area, even though high GPU loading is introduced, the pixel density per degree at the peripheral area is still low, so as to consume the computing resource.

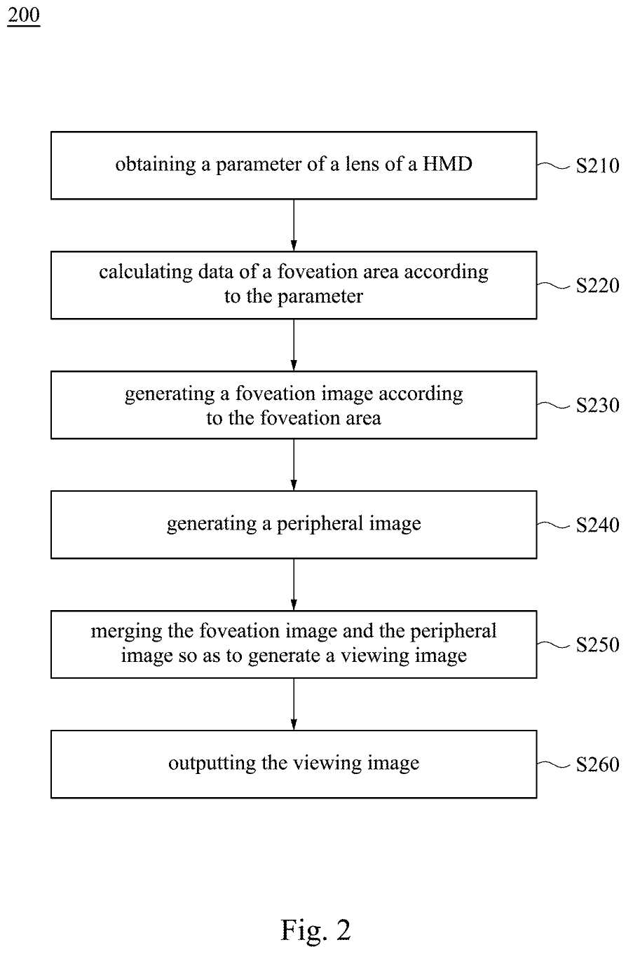

Details of the present disclosure are described in the paragraphs below with reference to an image processing method in FIG. 2, in which FIG. 2 is a flowchart of an operating method 200 suitable to be applied on the HMD device 105A in FIG. 1A or the tracking system 100B in FIG. 1B, in accordance with one embodiment of the present disclosure. However, the present disclosure is not limited to the embodiment below.

Reference is made to FIG. 2. FIG. 2 is a flowchart of an operating method 200 in accordance with some embodiments of the present disclosure. However, the present disclosure is not limited to the embodiment below.

It should be noted that the method can be applied to a tracking system or a HMD device having a structure that is the same as or similar to the structure of the tracking system 100B shown in FIG. 1B or the HMD device 105A shown in FIG. 1A. To simplify the description below, the embodiments shown in FIG. 1A or FIG. 1B will be used as an example to describe the method according to an embodiment of the present disclosure. However, the present disclosure is not limited to application to the embodiments shown in FIG. 1A or FIG. 1B.

It should be noted that, in some embodiments, the method may be implemented as a computer program. When the computer program is executed by a computer, an electronic device, or the one or more processor 150A, 150B in FIG. 1A or in FIG. 1B, this executing device perform the method. The computer program can be stored in a non-transitory computer readable medium such as a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this invention pertains.

In addition, it should be noted that in the operations of the following method, no particular sequence is required unless otherwise specified. Moreover, the following operations also may be performed simultaneously or the execution times thereof may at least partially overlap.

Furthermore, the operations of the following method may be added to, replaced, and/or eliminated as appropriate, in accordance with various embodiments of the present disclosure.

Reference is made to FIG. 2. The operating method 200 includes the operations below.

In operation S210, obtaining a parameter of a lens of a HMD. However, the lens 110A of the display circuit 120A or the lens 110B of the display circuit 120B is functional to image the content at the display circuit 120A or 120B with close range for the user. In some embodiments, the operation S210 may be operated by the processor 150A in FIG. 1A or the processor 150B in FIG. 1B. In some embodiments, the processor 150A may obtain parameter of the lens 110A from the HMD device 105A. In some embodiments, the processor 150B may obtain parameter of the lens 110B from the HMD device 105B.

In some other embodiments, the processor 150A or 150B may obtain parameter of the lens 105A or 105B from a database. The database can be, for example, inquired on the server of each manufacturer via the internet, or stored at the HMD device 105A or client device 107B and regularly updated.

In operation S220, calculating foveation area according to the parameter said above. In some embodiments, the operation S220 may be operated by the processor 150A in FIG. 1A or the processor 150B in FIG. 1B.

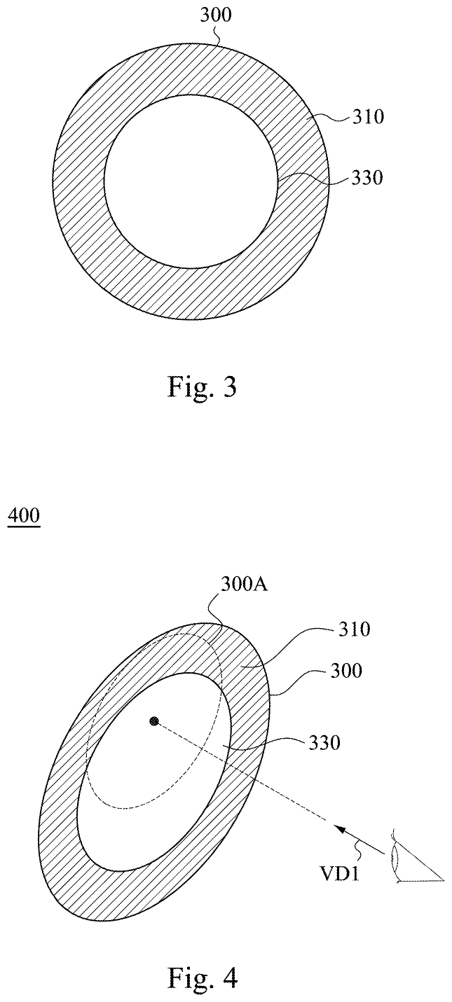

Reference is made to FIG. 3 at the same time. FIG. 3 is a schematic diagram of a display image 300 in accordance with some embodiments of the present disclosure. In some embodiments, due to the physical limit of the lens 110A and 110B, the display image 300 rendered by processor 150A or 150B includes, for example, a foveation area 330 and a peripheral area 310 illustrated in FIG. 3. The resolution of the peripheral area 310 is determined to be rendered for a lower resolution, while the resolution of the foveation area 330 is rendered for regular resolution. The processor 150A calculates the foveation area 330 as illustrated in FIG. 3 according to the parameter of the lens 110A. The processor 150B calculates the data of the foveation area 330 as illustrated in FIG. 3 according to the parameter of the lens 110B.

In some embodiments, the parameter of the lens 110A and the parameter of the lens 110B include focal lengths, field of views, or other process issues.

It should be noted that in some embodiments, the display image 300 may include not only foveation area 330 and peripheral area 310. The display image 300 may include several concentric areas or gradient areas with different resolution. How many concentric areas or gradient areas the display image 300 is divided into is determined according to the lens parameter.

In some embodiments, the processor 150A or the processor 150B is further configured to obtain data of performing eye tracking and to refine the rendering area such as display image 300, and particularly the foveation area 330 according to the data of performing eye tracking.

Reference is made to FIG. 4. FIG. 4 is a schematic diagram of an eye tracking operation 400 in accordance with some embodiments of the present disclosure. For example, as illustrated in FIG. 4, as the eye is gazing at vector VD1, the corresponding view seen on the display circuit 120A or 120B via the lens 110A of the HMD device 105A or the lens 110B of the HMD device 150B is the viewing image 300A.

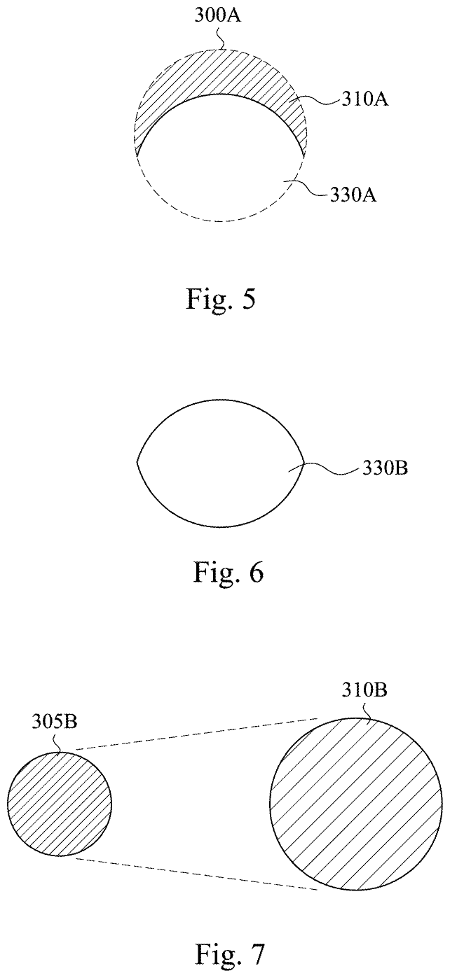

Reference is made to FIG. 5 at the same time. FIG. 5 is a schematic diagram of the viewing image 300A in accordance with some embodiments of the present disclosure. The viewing image 300A corresponds to the vector VD1. As shown in FIG. 5, the viewing image 300A includes foveation area 330A and the peripheral area 310A.

In operation S230, generating a foveation image according to the foveation area. In some embodiments, the operation S220 may be operated by the processor 150A in FIG. 1A or the processor 150B in FIG. 1B. In some embodiments, the processor 150A further includes a foveation camera circuit 152A. In some embodiments, the processor 150B further includes a foveation camera circuit 152B. In some embodiments, operation S230 may be operated by the foveation camera circuit 152A as illustrated in FIG. 1A or the foveation camera circuit 152B as illustrated in FIG. 1B.

For example, reference is made to FIG. 6 in conjunction with FIG. 4. FIG. 6 is a schematic diagram of the foveation image 330B in accordance with some embodiments of the present disclosure. The foveation image 330B includes the foveation area 330A in FIG. 5. As illustrated in FIG. 6, in some embodiments, the processor 150A or 150B refines the foveation area 330A according to the foveation area 330 and the user's gaze. Moreover, in some embodiments, a culling mask is set up when generating the foveation image. In some embodiments, the operation of eye tracking is performed by the eye tracking circuit 170A as illustrated in FIG. 1A.

In operation S240, generating a peripheral image. In some embodiments, the operation S240 may be operated by the processor 150A in FIG. 1A or the processor 150B in FIG. 1B. For example, reference is made to FIG. 7. FIG. 7 is a schematic diagram of the peripheral image 310A in accordance with some embodiments of the present disclosure. As illustrated in FIG. 7, in some embodiments, the processor 150A or 150B generates the peripheral image 305B. The processor 150A or 150B further up-scales the peripheral image 305B by enlarging the peripheral image 305B and generates the peripheral image 310B. After up-scaling the peripheral image 305B, the enlarged peripheral image 305B is able to be merged with the foveation image 330B of the same size. In some embodiments, the peripheral image 330B includes the peripheral area 330A in FIG. 5.

In some embodiments, the processor 150A further includes a peripheral camera circuit 154A. In some embodiments, the processor 150B further includes a peripheral camera circuit 154B. In some embodiments, operation S240 may be operated by the peripheral camera circuit 154A as illustrated in FIG. 1A or the peripheral camera circuit 154B as illustrated in FIG. 1B.

In some embodiments, the processor 150A or 150B is further configured to perform anti-aliasing process while upscaling the peripheral image 310B. In some embodiments, after upscaling the peripheral image 310B, the resolution of the peripheral image 310B is lower than the resolution of the foveation image 330B. By applying anti-aliasing process edge flickering artifacts is reduced while upscaling the peripheral image 310B.

In operation S250, merging the foveation image and the peripheral image so as to generate a viewing image. In some embodiments, the operation S240 may be operated by the processor 150A in FIG. 1A or the processor 150B in FIG. 1B. For example, the processor 150A or 150B merges the foveation image 330B as illustrated in FIG. 6 and the peripheral image 310B as illustrated in FIG. 7 so as to generate the viewing image 300A as illustrated in FIG. 5. In some embodiments, while merging the foveation image 330B and the peripheral image 310B, a boundary blending technique is applied to make the boundary between the foveation image 330B and the peripheral image 310B smoother.

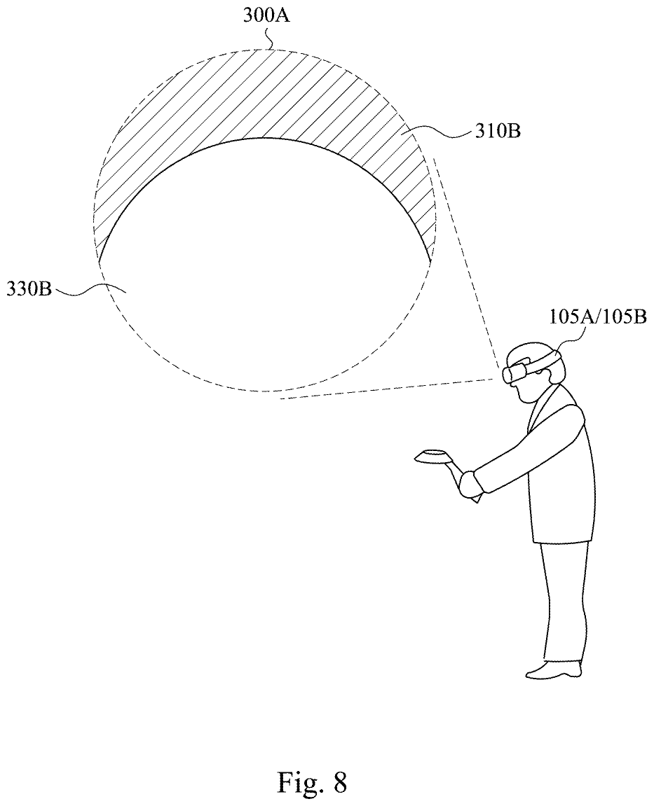

In operation S260, outputting the viewing image. In some embodiments, the operation S240 may be operated by the processor 150A in FIG. 1A or the processor 150B in FIG. 1B. Reference is made to FIG. 8. FIG. 8 is a schematic diagram illustrating the output of the viewing image 300A seen on the display circuit 120A or 120B via the lens 110A or 110B by a user. As illustrated in FIG. 8, the user wears the HMD device 105A as illustrated in FIG. 1 or the HMD device 105B as illustrated in FIG. 2. The HMD device 105A or 105B renders the viewing image 300A as illustrated in FIG. 5, and the user is able to see the viewing image 300A on the display circuit 120A or 120B through the lens 110A or 1108 of the HMD device 105A or 1058. The viewing image 300B includes the foveation image 330B and the peripheral image 310B. In some embodiments, the merged viewing image 300A is transmitted from the host device 107B to the client device 105B, and the merged viewing image 300A is rendered on the display circuit 120B of the client device 105B.

Through the operations of the embodiments described above, the tracking system 100B or the HMD 105A in the present disclosure may optimize the viewing quality while reducing the render resolution. In detail, by considering the impact of lens and user's gaze, the computing resource can be reduced for the image rendering. Particularly, based on characteristic of the lens, parts of display image cannot be presented perfectly via the lens on the display for the user. Thus, the resolution with respect to the parts of the display image is adjustable to reduce the computing burden when rendering.

Although the present invention has been described in considerable detail with reference to certain embodiments thereof, other embodiments are possible. Therefore, the scope of the appended claims should not be limited to the description of the embodiments contained herein.

What is claimed is:

1. An operating method of a tracking system, comprising:
obtaining, by a processor, a parameter of a lens of a HMD (Head Mount Display) device;
calculating, by the processor, data of a foveation area according to the parameter;
generating, by the processor, a foveation image according to the foveation area;
generating, by the processor, a peripheral image whose resolution is lower than a resolution of the foveation image;
merging, by the processor, the foveation image and the peripheral image to generate a viewing image; and
outputting, by the processor, the viewing image.

2. The operating method as claimed in claim 1, wherein the parameter comprises a focal length of the lens and a field of view of the lens.

3. The operating method as claimed in claim 1, further comprising:
obtaining data of performing eye tracking; and
refining the data of the foveation area according to the data of performing eye tracking.

4. The operating method as claimed in claim 1, further comprising:
obtaining the parameter of the lens from at least one of a database and the HMD device.

5. The operating method as claimed in claim 1, further comprising:
upscaling the peripheral image; and
performing anti-aliasing process while upscaling the peripheral image.

6. The operating method as claimed in claim 1, wherein merging the foveation image and the peripheral image further comprises:
merging the foveation image and the peripheral image with boundary blending technique.

7. The operating method as claimed in claim 1, further comprising:
setting up a culling mask when generating the foveation image.

8. A HMD device, comprising:
a display circuit comprising a lens; and
a processor being configured to:
obtain a parameter of the lens;
calculate data of a foveation area according to the parameter;
generate a foveation image according to the foveation area;
generate a peripheral image whose resolution is lower than a resolution of the foveation image; and
merge the foveation image and the peripheral image to generate a viewing image, and to output the viewing image.

9. The HMD device as claimed in claim 8, wherein the processor is further configured to obtain data of performing eye tracking and to refine the data of the foveation area according to the data of performing eye tracking.

10. The HMD device as claimed in claim 9, wherein the processor is further configured to upscale the peripheral image and to perform anti-aliasing process while upscaling the peripheral image.

11. The HMD device as claimed in claim 9, wherein the processor is further configured to merge the foveation image and the peripheral image with boundary blending technique.

12. The HMD device as claimed in claim 9, wherein the processor is further configured to set up a culling mask when generating the foveation image.

13. A tracking system, comprising:
a client device with a lens; and
a host device, comprising:
a processor being configured to:
obtain a parameter of the lens;
calculate data of a foveation area according to the parameter;
generate a foveation image according to the foveation area;
generate a peripheral image whose resolution is lower than a resolution of the foveation image; and
merge the foveation image and the peripheral image to generate a viewing image, and to output the viewing image.

14. The tracking system as claimed in claim 13, wherein the processor of the host device is further configured to obtain data of performing eye tracking and to refine the data of the foveation area according to the data of performing eye tracking.

15. The tracking system as claimed in claim 13, wherein the processor is further configured to upscale the peripheral image and to perform anti-aliasing process while upscaling the peripheral image.

16. The tracking system as claimed in claim 13, wherein the processor is further configured to merge the foveation image and the peripheral image with boundary blending technique.

17. The tracking system as claimed in claim 13, wherein the processor is further configured to set up a culling mask when generating the foveation image.
